(19) United States
(12) Patent Application Publication
(10) Pub. No.: US 2014/0066341 A1
(43) Pub. Date: Mar. 6, 2014

(54) NON-AQUEOUS DRILLING ADDITIVE USEFUL TO IMPROVE LOW SHEAR RATE VISCOSITY

(71) Applicants: David DINO, Cranbury, NJ (US); Kamal Said Kamal ELSAYED, Plainsboro, NJ (US); Yanhui CHEN, Plainsboro, NJ (US); Jeffrey THOMPSON, Hightstown, NJ (US)

(72) Inventors: David DINO, Cranbury, NJ (US); Kamal Said Kamal ELSAYED, Plainsboro, NJ (US); Yanhui CHEN, Plainsboro, NJ (US); Jeffrey THOMPSON, Hightstown, NJ (US)

(73) Assignee: ELEMENTIS SPECIALTIES, INC., East Windsor, NJ (US)

(21) Appl. No.: 13/604,328

(22) Filed: Sep. 5, 2012

(51) Int. Cl. C09K 8/32

(52) U.S. Cl. 507/131

(57) ABSTRACT

A method to control viscosity with respect to shear rate for an oil based drilling fluid by adding a polyamide drilling fluid additive to the oil based drilling fluid. In some embodiments, a polyamide drilling fluid additive includes a reaction product of (i) a carboxylic acid with a single carboxylic moiety or two carboxylic moieties, and (ii) a polyamine having an amine functionality of two or more; and placing the placing the oil based drilling fluid into the subterranean formation.

### BACKGROUND OF THE INVENTION

Drilling fluids have been used since the very beginning of oil well drilling operations in the United States and drilling fluids and their chemistry are an important area for scientific and chemical investigations. Certain uses and desired properties of drilling fluids are reviewed in U.S. Pat. Nos. 7,799,742, 7,345,010, 6,339,048 and 6,462,096, issued to the assignee of this application, the entire disclosures of which are incorporated herein by reference.

Nevertheless, the demands of the oil-well drilling environment require increasing improvements in rheology control over broad temperature and shear ranges. This becomes particularly true, for example, as the search for new sources of oil involves greater need to explore in deep water areas and to employ horizontal drilling techniques.

### SUMMARY OF THE INVENTION

The present disclosure provides for a method of drilling in a subterranean formation. In some embodiments, the method includes the steps of: providing an oil based drilling fluid by combining an oil based continuous phase with a drilling fluid additive, the oil based drilling fluid having a low shear viscosity and a high shear viscosity, the drilling fluid additive comprising a polyamide having constituent units of: a carboxylic acid unit having a single carboxylic moiety or two carboxylic moieties: and a polyamine unit having at least two primary amino groups and optionally at least one secondary amino group, wherein the drilling fluid additive maintains or increases the low shear viscosity of the oil based drilling fluid while simultaneously maintaining a substantially constant high shear viscosity of the oil based drilling fluid compared to a low shear viscosity and high shear viscosity of an oil based drilling fluid without said polyamide. The oil based drilling fluid is then placed into the subterranean formation. In some such embodiments, the polyamide drilling fluid additive is added to the oil-based drilling fluid at a concentration ranging from 0.5 ppb to 5 ppb. In some such embodiments, the oil based continuous phase comprises: diesel oil, mineral oil, synthetic oil, vegetable oil, fish oil, paraffinics, ester-based oils and combinations thereof.

In some other embodiments, the method includes the steps of: providing an oil based drilling fluid by combining an oil based continuous phase with a drilling fluid additive, the oil based drilling fluid having a low shear viscosity and a high shear viscosity, the drilling fluid additive comprising polyamide which is a reaction product of: a carboxylic acid having a single carboxylic moiety or two carboxylic moieties; and a polyamine having at least two primary amino groups and optionally at least one secondary amino group wherein the drilling fluid additive increases a low shear viscosity of the oil based drilling fluid while simultaneously maintaining a substantially constant high shear viscosity of the oil based drilling fluid. The oil based drilling fluid is then placed into the subterranean formation. In some such embodiments, the polyamide drilling fluid additive is added to the oil-based drilling fluid at a concentration ranging from 0.5 ppb to 5 ppb. In some such embodiments, the oil based continuous phase comprises: diesel oil, mineral oil, synthetic oil, vegetable oil, fish oil, paraffinics, ester-based oils and combinations thereof.

In some embodiments, the carboxylic acid unit having one carboxylic moiety is derived from one or more compounds of the formula R¹—COOH wherein R¹ is a saturated or unsaturated hydrocarbon having from 8 carbon atoms to 22 carbon atoms. In some such embodiments, R¹ is an unsaturated hydrocarbon having from 8 carbon atoms to 22 carbon atoms and wherein R¹ is optionally substituted with one or more hydroxyl groups.

In some other embodiments, the carboxylic acid unit having one carboxylic moiety is derived from one or more compounds of the formula R¹—COOH wherein R¹ is a saturated or unsaturated hydrocarbon having from 12 carbon atoms to 22 carbon atoms. In some such embodiments, R¹ is an unsaturated hydrocarbon having from 12 carbon atoms to 22 carbon atoms and wherein R¹ is optionally substituted with one or more hydroxyl groups.

In still yet other embodiments, the carboxylic acid unit having one carboxylic moeity is derived from a monocarboxylic acid selected from the group consisting of: dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof.

In yet other embodiments, the carboxylic acid unit having two carboxylic moieties is derived from a dimer fatty acid. In some such embodiments, the dimer fatty acid is selected from the group consisting of hydrogenated, partially hydrogenated and non-hydrogenated dimer acids with from about 20 to about 48 carbon atoms.

In some embodiments, the polyamine unit is derived from a linear or branched aliphatic or aromatic diamine having from 2 to 36 carbon atoms. In some such embodiments, the polyamine unit is derived from a polyamine comprising ethylenediamine, tetramethylenediamine, pentamethylenediamine, hexamethylenediamine, diethylenetriamine, metaxylene diamine and mixtures thereof.

In some embodiments, the method comprises the step of adding one or more emulsifiers to the oil-based drilling fluid.

In some embodiments, the method comprises the step of adding an organoclay to the oil-based drilling fluid. In other embodiments, the method comprises the step of adding a non-organoclay rheological additive to the oil-based drilling fluid.

In some embodiments, the oil based drilling fluid has a mud weight of at least 16 ppg and the amount of polyamide drilling fluid additive is less than the amount of a rheology modifier consisting of an organoclay rheology modifier required to maintain the low shear viscosity of the oil based drilling fluid.

In some embodiments, the method comprises the step of adding a fluid loss reducing additive to the oil-based drilling fluid.

In some embodiments, the drilling fluid maintains the low shear viscosity by ±50% after the drilling fluid is heated to temperatures up to about 300° F. and subsequently cooled to 120° F.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

In the drawings:

FIG. 1 illustrates an embodiment of the present invention in a graph of viscosity (dial reading of OFI-900) versus shear rate (rpm of OFI-900).

FIG. 2 illustrates the synergistic interaction of an organoclay and polyamide as used in embodiments of the present invention.

FIG. 3 illustrates the temperature stability of an embodiment of the present invention.

### DETAILED DESCRIPTION OF THE EMBODIMENTS

The present invention provides for methods to control viscosity with respect to shear rate for an oil based drilling fluid by adding a polyamide drilling fluid additive to the oil based drilling fluid. In some embodiments, a polyamide drilling fluid additive includes a reaction product of (i) a carboxylic acid with a single carboxylic moiety or two carboxylic acid moieties, and (ii) a polyamine having an amine functionality of two or more; and placing the oil based drilling fluid into the subterranean formation. In other embodiments, a polyamide drilling fluid additive consists of a reaction product of (i) a carboxylic acid with a single carboxylic moiety or two carboxylic acid moieties, and (ii) a polyamine having an amine functionality of two or more. In yet other embodiments, the polyamide drilling fluid additive includes a polyamide having constituent units of: a carboxylic acid unit with a single carboxylic moiety or two carboxylic acid moieties and a polyamine unit having at least two primary amino groups and optionally at least one secondary amino group. In still yet other embodiments, the polyamide drilling fluid additive includes a polyamide consisting of constituent units of: a carboxylic acid unit with a single carboxylic moiety or two carboxylic acid moieties and a polyamine unit having at least two primary amino groups and optionally at least one secondary amino group.

For the purposes of this disclosure, polyamides include bisamide and polyamide compositions. The carboxylic acids and polyamines which may be used to produce various embodiments of a polyamide as a reaction products or from which the constituent units are derived are described below.

Carboxylic Acids

According to some embodiments, the carboxylic acid reactant and/or carboxylic acid from which a carboxylic acid unit is derived (individually or collectively referred to herein as “carboxylic acid”) includes various carboxylic acids having a single carboxylic moiety or two carboxylic acid moieties. In one embodiment, the carboxylic acid includes one or more compounds of the formula R¹—COOH wherein R¹ is a saturated or unsaturated hydrocarbon having from 8 carbon atoms to 22 carbon atoms. In another embodiment, R¹ is an unsaturated hydrocarbon having from 8 carbon atoms to 22 carbon atoms and wherein R¹ is optionally substituted with one or more hydroxyl groups. In one embodiment, the carboxylic acid includes one or more compounds of the formula R¹—COOH wherein R¹ is a saturated or unsaturated hydrocarbon having from 12 carbon atoms to 22 carbon atoms. In another embodiment, R¹ is an unsaturated hydrocarbon having from 12 carbon atoms to 22 carbon atoms and wherein R¹ is optionally substituted with one or more hydroxyl groups. In yet another embodiment, the carboxylic acid includes one or more of the following monocarboxylic acids: dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof. In other embodiments, the carboxylic acid includes one or more of the following monocarboxylic acids: dodecanoic acid, octadecanoic acid, docosanoic acid, 12-hydroxy-octadecanoic acid, and 12-hydroxy-9-cis-octadecenoic acid and mixtures thereof. In one embodiment, the carboxylic acid is dodecanoic acid. In another embodiment, the carboxylic acid is docosanoic acid. In another embodiment, the carboxylic acid is 12-hydroxy-octadecanoic acid.

According to some embodiments, the carboxylic acid may include a mixture of two or more carboxylic acids wherein the first carboxylic acid includes one or more compounds of the formula R¹—COOH wherein R¹ is a saturated or unsaturated hydrocarbon having from 12 carbon atoms to 22 carbon atoms and the second carboxylic acid includes one or more compounds of the formula R²—COOH wherein R² is a saturated or unsaturated hydrocarbon having from 6 carbon atoms to 10 carbon atoms. Exemplary mixtures of carboxylic acids include: dodecanoic acid/hexanoic acid; 12-hydroxy-octadecanoic acid/hexanoic acid; and 12-hydroxy-octadecanoic acid/decanoic acid.

In yet another embodiment, the carboxylic acid may have two carboxylic acid groups. In some such embodiments, the carboxylic acid is a dimer acid. In some embodiments, the carboxylic acid includes dimer acids of C₁₆ and/or C₁₈ fatty acid. In certain embodiments, such dimer acids are fully hydrogenated, partially hydrogenated, or not hydrogenated at all. In some embodiments, dimer acids include products resulting from the dimerization of C₁₆ to C₁₈ unsaturated fatty acids.

In some embodiments, the dimer carboxylic acid has two carboxylic acid moieties and has an average of about 18 to about 48 carbon atoms. In some embodiments, the dimer carboxylic acid has two carboxylic acid moieties and has an average of about 20 to 40 carbon atoms. In one embodiment, the dimer carboxylic acid has two carboxylic acid moieties and has an average of about 36 carbon atoms.

In certain embodiments, a dimer carboxylic acid may be prepared from C₁₈ fatty acids, such as oleic acids. Examples of suitable dimer acids are described in U.S. Pat. Nos. 2,482,760, 2,482,761, 2,731,481, 2,793,219, 2,964,545, 2,978,468, 3,157,681, and 3,256,304, the entire disclosures of which are incorporated herein by reference.

Examples of suitable dimer acids include the Empol® product line available from Cognis Inc. (eg: Empol® 1061), and Pripol® dimer acids available from Uniqema (eg: Pripol® 1013).

In some embodiments, the dimer carboxylic acid includes an amount of a trimer carboxylic acid. In some embodiments, trimer acids are included in the drilling fluid additive though the addition of commercial dimer acid products such as Empol® 1061 or Pripol® 1013. In some embodiments, the carboxylic acid does not include a trimer acid.

Many commercially available dimer fatty acids contain a mixture of monomer, dimer, and trimer acids. In some embodiments, the dimer carboxylic acid has a specific dimer content as increased monomer and trimer concentration may hinder the additive's performance. In some embodiments, commercial products are distilled or otherwise processed to ensure certain suitable dimer carboxylic acid content. In some embodiments, a suitable dimer carboxylic acid has a dimer content of at least about 80%. In some embodiments, suitable dimer carboxylic acid has a dimer content of at least about 90%. An example of a suitable dimer carboxylic acid includes Empol® 1061, which has a dimer carboxylic acid content of 92.5%-95.5%, a trimer carboxylic acid content of 1.5%-3.5% and a monocarboxylic acid content of 2.5%-5.0%.

Polyamines

According to some embodiments, the polyamine reactant and/or polyamine from which a polyamine unit is derived (individually or collectively referred to herein as “polyamine”) includes a polyamine having an amine functionality of two or more. In one embodiment, the polyamine includes a linear or branched aliphatic or aromatic diamine having from 2 to 36 carbon atoms. Di-, tri-, and polyamines and their combinations may be suitable. Examples of such amines include one or more of the following di- or triamines: ethylenediamine, tetramethylenediamine, pentamethylenediamine, hexamethylenediamine, diethylenetriamine, metaxylene diamine, dimer diamines and mixtures thereof. In yet another embodiment, the polyamine includes one or more of the following: ethylenediamine, hexamethylenediamine, diethylenetriamine, metaxylene diamine, dimer diamines and mixtures thereof. In another embodiment, the polyamine includes a polyethylene polyamine of one or more of the following: ethylenediamine, hexamethylenediamine, diethylenetriamine and mixtures thereof.

In some embodiments, di-, tri-, and polyamines and their combinations are suitable for use in this invention. In such embodiments, polyamines include ethylenediamine, diethylenetriamine, triethylenetetramine, tetraethylenepentamine and other members of this series. In one such embodiment, a suitable triamine is diethylenetramine (DETA). DETA has been assigned a CAS No. of 111-40-0 and is commercially available from Huntsman International.

In other embodiments, a suitable polyamine includes aliphatic dimer diamine, cycloaliphatic dimer diamine, aromatic dimer diamine and mixtures thereof and Priamine® 1074 from Croda Coatings and Polymers.

Exemplary Drilling Fluid Additive Compositions

In one embodiment, the polyamide drilling fluid additive includes a compositions based on a polyethylene polyamine. In one such embodiment, the polyamide drilling fluid includes a composition having of constituent units derived from: dodecanoic acid and diethylene triamine. In another such embodiment, the polyamide drilling fluid additive includes a composition having of constituent units derived from: docosanoic acid and diethylene triamine. In another such embodiment, the polyamide drilling fluid additive includes a composition having of constituent units derived from: 12-hydroxy-octadecanoic acid and diethylene triamine. In yet another such embodiment, the polyamide drilling fluid additive includes a composition having of constituent units derived from: 12-hydroxy-octadecanoic acid, hexanoic acid and ethylene diamine. In still yet another such embodiment, the polyamide drilling fluid additive includes a composition having of constituent units derived from: 12-hydroxy-octadecanoic acid, decanoic acid and ethylene diamine. In other embodiments, the polyamide drilling fluid additive includes a composition having constituent units derived from: a C₁₆-C₁₈ dimer carboxylic acid and diethylene triamine.

In one embodiment, the polyamide drilling fluid additive includes a composition based on a dimer diamine. In one such embodiment, the polyamide drilling fluid includes a composition having of constituent units derived from: docosanoic acid and dimer diamine. In another such embodiment, the polyamide drilling fluid additive includes a composition having of constituent units derived from: 12-hydroxy-octadecanoic acid and dimer diamine. In other embodiments, the polyamide drilling fluid additive includes a composition having constituent units derived from: a C₁₆-C₁₈ dimer carboxylic acid and ethylene diamine.

Making the Drilling Fluid Additive

Specifics on processing of polyamines and carboxylic acids are well known and can be used in making the reaction product for incorporation in the drilling fluid additive. In some embodiments, the molar ratio between the amine functional group and carboxyl functional group is about 4:1 to about 1:0.5. In some embodiments, the molar ratio between the amine functional group and carboxyl functional group is about 3:1 to about 1:1. In some embodiments, the molar ratio between the amine functional group and carboxyl functional group is: about 3:1; about 2:1; and about 1:1. In some embodiments, the molar ratio between the amine functional group and carboxyl functional group is about 1:1. In some embodiments, mixtures of more than one carboxylic acid and/or more than one polyamine can be used.

Preparation of the Drilling Fluids

In some embodiments, compositions according to the present invention may be used as an additive to oil-based drilling fluids. In some embodiments, compositions according to the present invention may be used as an additive for oil-based invert emulsion drilling fluids employed in a variety of drilling applications.

The term oil-based drilling fluid is defined as a drilling fluid in which the continuous phase is hydrocarbon based. Oil-based drilling fluids formulated with over 5% water or brine may be classified as oil-based invert emulsion drilling fluids. In some embodiments, oil-based invert emulsion drilling fluids may contain water or brine as the discontinuous phase in any proportion up to about 50%. Oil muds may include invert emulsion drilling fluids as well as all oil based drilling fluids using synthetic, refined or natural hydrocarbon base as the external phase.

According to some embodiments, a process for preparing invert emulsion drilling fluids (oil muds) involves using a mixing device to incorporate the individual components making up that fluid. In some embodiments, primary and secondary emulsifiers and/or wetting agents (surfactant mix) are added to the base oil (continuous phase) under moderate agitation. The water phase, typically a brine, may be added to the base oil/surfactant mix along with alkalinity control agents and acid gas scavengers. In some embodiments, rheological additives as well as fluid loss control materials, weighting agents and corrosion inhibition chemicals may also be included. The agitation may then be continued to ensure dispersion of each ingredient and homogenize the resulting fluidized mixture.

A drilling fluid can be characterized by its mud weight, mass per unit volume. Mud weight can be reported in units of pounds/gallon (“ppg”). The mud weight typically ranges from 8 ppg up to 18 ppg depending upon the base oil of the drilling fluid.

Oil-Based Phase

According to some embodiments, the base oil (or interchangeably) continuous phase includes diesel oil, mineral oil, synthetic oil, vegetable oil, fish oil, paraffinics, and/or ester-based oils which can all be used as single components or as blends.

Brine Content

In some embodiments, water in the form of brine is often used in forming the internal phase of the drilling fluids. According to some embodiments, water can be defined as an aqueous solution which can contain from about 10 to 350,000 parts-per-million of metal salts such as lithium, sodium, potassium, magnesium, cesium, or calcium salts. In some embodiments, brines used to form the internal phase of a drilling fluid according to the present invention can also contain about 5% to about 35% by weight calcium chloride and may contain various amounts of other dissolved salts such as sodium bicarbonate, sodium sulfate, sodium acetate, sodium borate, potassium chloride, sodium chloride or formates (such as sodium, calcium, or cesium). In some embodiments, glycols or glycerin can be used in place of or in addition to brines.

In some embodiments, the ratio of water (brine) to oil in the emulsions according to the present invention may provide as high of brine content as possible while still maintaining a stable emulsion. In some embodiments, suitable oil/brine ratios may be in the range of about 97:3 to about 50:50. In some embodiments, suitable oil/brine ratios may be in the range of about 90:10 to about 60:40, or about 80:20 to about 70:30. In some embodiments, the preferred oil/brine ratio may depend upon the particular oil and mud weight. According to some embodiments, the water content of a drilling fluid prepared according to the teachings of the invention may have an aqueous (water) content of about 0 to 50 volume percent.

Organoclay Rheology Modifier s and Rheology Modifiers Other than Organoclays

In some embodiments, the drilling fluid additive includes an organoclay rheology modifier. According to some embodiments, organoclays made from at least one of bentonite, hectorite and attapulgite clays are added to the drilling fluid additive. In one embodiment, the organoclay is based on bentonite, hectorite or attapulgite exchanged with a quaternary ammonium salt having the following formula:

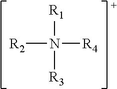

where R₁, R₂, R₃ or R₄ are selected from (a) benzyl or methyl groups; (b) linear or branched long chain alkyl radicals having 10 to 22 carbon atoms; (c) aralkyl groups such as benzyl and substituted benzyl moieties including fused ring moieties having linear or branched 1 to 22 carbon atoms in the alkyl portion of the structure; (d) aryl groups such as phenyl and substituted phenyl including fused ring aromatic substituents; (e) beta, gamma unsaturated groups; and (f) hydrogen.

In another embodiment, the organoclay rheology modifier is based on bentonite, hectorite or attapulgite exchanged with a quaternary ammonium ion including dimethyl bis[hydrogenated tallow] ammonium chloride (“2M2HT”), benzyl dimethyl hydrogenated tallow ammonium chloride (“B2 MHT”), trimethyl hydrogenated tallow ammonium chloride (“3 MHT”) and methyl benzyl bis[hydrogenated tallow] ammonium chloride (“MB2HT”).

There are a large number of suppliers of such clays in addition to Elementis Specialties' BENTONE® product line including Rockwood Specialties, Inc. and Sud Chemie GmbH.

In addition to or in place of organoclays, polymeric rheological additives, such as THIXATROL® DW can be added to the drilling fluid. Examples of suitable polymeric rheological additives are described in U.S. Pat. Nos. 7,345,010; 7,799,742; and 7,906,461, each incorporated by reference herein in its entirety.

Emulsifiers

According to some embodiments, an emulsifier can also be added to the drilling fluid in order to form a more stable emulsion. The emulsifier may include organic acids, including but not limited to the monocarboxyl alkanoic, alkenoic, or alkynoic fatty acids containing from 3 to 20 carbon atoms, and mixtures thereof. Examples of this group of acids include stearic, oleic, caproic, capric and butyric acids. In some embodiments, adipic acid, a member of the aliphatic dicarboxylic acids, can also be used. According to some embodiments, suitable surfactants or emulsifiers include fatty acid calcium salts and lecithin. In other embodiments, suitable surfactants or emulsifiers include oxidized tall oil, polyaminated fatty acids, and partial amides of fatty acids.

In some embodiments, heterocyclic additives such as imidazoline compounds may be used as emulsifiers and/or wetting agents in the drilling muds. In other embodiments, alkylpyridines may be used to as emulsifiers and/or wetting agents in the drilling muds.

Industrially obtainable amine compounds for use as emulsifiers may be derived from the epoxidation of olefinically unsaturated hydrocarbon compounds with subsequent introduction of the N function by addition to the epoxide group. The reaction of the epoxidized intermediate components with primary or secondary amines to form the corresponding alkanolamines may be of significance in this regard. In some embodiments, polyamines, particularly lower polyamines of the corresponding alkylenediamine type, are also suitable for opening of the epoxide ring.

Another class of the oleophilic amine compounds that may be suitable as emulsifiers are aminoamides derived from preferably long-chain carboxylic acids and polyfunctional, particularly lower, amines of the above-mentioned type. In some embodiments, at least one of the amino functions is not bound in amide form, but remains intact as a potentially salt-forming basic amino group. The basic amino groups, where they are formed as secondary or tertiary amino groups, may contain hydroxyalkyl substituents and, in particular, lower hydroxyalkyl substituents containing up to five and in some embodiments up to three carbon atoms in addition to the oleophilic part of the molecule.

According to some embodiments, suitable N-basic starting components for the preparation of such adducts containing long-chain oleophilic molecule constituents may include but are not limited to monoethanolamine or diethanolamine.

Weighting Agents

In some embodiments, weighting materials are also used to weight the drilling fluid additive to a desired density. In some embodiments, the drilling fluid is weighted to a density of about 8 to about 18 pounds per gallon and greater. Suitable weighting materials may include barite, ilmenite, calcium carbonate, iron oxide and lead sulfide. In some embodiments, commercially available barite is used as a weighting material.

Filtrate Reducers

In some embodiments, fluid loss control materials are added to the drilling fluid to control the seepage of drilling fluid into the formation. In some embodiments, fluid loss control materials are lignite-based or asphalt-based. Suitable filtrate reducers may include amine treated lignite, gilsonite and/or elastomers such as styrene butadiene.

Blending Process

In some embodiments, drilling fluids may contain about 0.1 pounds to about 15 pounds of the drilling fluid additive per barrel of fluids. In other embodiments, drilling fluids may contain about 0.1 pounds to about 10 pounds of the drilling fluid additive per barrel of fluids, and in still other embodiments, drilling fluids may contain about 0.1 pounds to about 5 pounds of the drilling fluid additive per-barrel of fluids. One of skill in the art will understand that “ppb” means pounds per barrel.

As shown above, a skilled artisan will readily recognize that additional additives such as weighting agents, emulsifiers, wetting agents, viscosifiers, fluid loss control agents, and other agents can be used with a composition according to the present invention. A number of other additives besides rheological additives regulating viscosity and anti-settling properties can also be used in the drilling fluid so as to obtain desired application properties, such as, for example, anti-settling agents and fluid loss-prevention additives.

In some embodiments, the drilling fluid additive can be cut or diluted with solvent to vary the pour point or product viscosity. Any suitable solvent or combination of solvents may be used. Suitable solvents may include but are not limited to: diesel, mineral or synthetic oils, block copolymers of EO/PO and/or styrene/isoprene, glycols including polyalkylene glycols, alcohols including polyethoxylated alcohols, polyethoxylated alkyl phenols or polyethoxylated fatty acids, various ethers, ketones, amines, amides, terpenes and esters.

As shown above, a skilled artisan will readily recognize that additional additives: weighting agents, emulsifiers, wetting agents, viscosifiers, fluid loss control agents, and other agents can be used with this invention. A number of other additives besides rheological additives regulating viscosity and anti-settling properties, providing other properties, can also be used in the fluid so as to obtain desired application properties, such as, for example, anti-settling agents and fluid loss-prevention additives.

Method of Use

In some embodiments, a polyamide drilling fluid additive, the various embodiments as discussed above, may be added to a drilling fluid. In some embodiments, the drilling fluid additive may be added to a drilling fluid in combination with other additives, such as organoclay rheology modifiers discussed above.

In some embodiments, a polyamide drilling fluid additive is added to a drilling fluid in an amount of about 0.1 pounds/barrel (“ppb”) to about 30 ppb of drilling fluid. In other embodiments, a polyamide drilling fluid additive is added to a drilling fluid in an amount of about 0.25 ppb to about 15.0 ppb drilling fluid. In other embodiments, a polyamide drilling fluid additive is added to a drilling fluid in an amount of about 0.25 ppb to about 5 ppb drilling fluid. In some embodiments, a polyamide drilling fluid additive is added to a drilling fluid in an amount of about 0.5 ppb drilling fluid. In some embodiments, a polyamide drilling fluid additive is added to a drilling fluid in an amount of about 0.75 ppb drilling fluid. In some embodiments, a polyamide drilling fluid additive is added to a drilling fluid in an amount of about 1.0 ppb drilling fluid. In some embodiments, a polyamide drilling fluid additive is added to a drilling fluid in an amount of about 1.5 ppb drilling fluid. In some embodiments, a polyamide drilling fluid additive is added to a drilling fluid in an amount of about 2.0 ppb drilling fluid. In some embodiments, a polyamide drilling fluid additive is added to a drilling fluid in an amount of about 5.0 ppb drilling fluid. In some embodiments, a smaller amount of a polyamide drilling fluid additive of the present invention is required to achieve comparable rheological stability results as a known drilling fluid additive.

The drilling fluid containing a polyamide drilling fluid additive may be characterized by several rheological or hydraulic aspects, i.e., ECD, high shear rate viscosity, low shear rate viscosity, plastic viscosity, regulating property viscosity, low shear rate yield point, yield point and Tau 0, of a drilling fluid. The rheological aspects may be determined using a Fann viscometer as per standard procedures found in API RP13B-2 “Standard Procedures for Field Testing Oil-based Drilling Fluids”. Viscosity readings can be measured at 600 rpm, 300 rpm, 200 rpm, 100 rpm, 6 rpm and 3 rpm. ECD can be determined by: standard hydraulics calculations found in API RP13D “Rheology and Hydraulics of Oil-well Drilling Fluids.” For the purposes of this invention high shear rate viscosity (“HSR”) corresponds to the dial reading measured at 600 rpm as per API RP13B-2 procedures. For the purposes of this invention, low shear rate viscosity (“LSR”) corresponds to the dial reading measured at 6 rpm as per API RP 13B-2 procedures. Plastic viscosity (“PV”) corresponds to the 600 rpm reading minus the 300 rpm reading. Yield Point (“YP”) corresponds to the 300 rpm reading minus plastic viscosity.

In some embodiments, a polyamide drilling fluid additive maintains a substantially constant high shear viscosity of an oil based drilling fluid when the drilling fluid is placed into a subterranean formation. For the purposes of the embodiments disclosed herein, “substantially constant high shear viscosity” means a change in high shear viscosity ranging from −30% to +30% compared to the high shear viscosity of an oil based drilling fluid without the polyamide drilling fluid additive.

In some embodiments, a polyamide drilling fluid additive is added to an oil based drilling fluid, wherein the polyamide drilling fluid additive maintains or increases the low shear viscosity of the oil based drilling fluid while simultaneously maintaining a substantially constant high shear viscosity of the oil based drilling fluid compared to a low shear viscosity and high shear viscosity of an oil based drilling fluid without said polyamide drilling fluid additive. In some such embodiments, the oil based drilling fluid further contains an organoclay rheology modifier.

In some other embodiments, a polyamide drilling fluid additive is added to an oil based drilling fluid, wherein such polyamide drilling fluid additive increases the low shear viscosity of the oil based drilling fluid while simultaneously maintaining a substantially constant high shear viscosity of the oil based drilling fluid compared to a low shear viscosity and high shear viscosity of an oil based drilling fluid without said polyamide drilling fluid additive. In some embodiments, the oil based drilling fluid further contains an organoclay rheology modifier. In other such embodiments, the low shear viscosity of the drilling fluid can be increased by up to 200%.

In still other embodiments, a polyamide drilling fluid additive is added to an oil based drilling fluid, wherein such polyamide drilling fluid additive maintains the low shear viscosity of the oil based drilling fluid while simultaneously maintaining a substantially constant high shear viscosity of the oil based drilling fluid compared to a low shear viscosity and high shear viscosity of an oil based drilling fluid without said polyamide drilling fluid additive. In some other embodiments, the oil based drilling fluid further contains an organoclay rheology modifier. In some other such embodiments, the low shear viscosity of the drilling fluid is maintained by ±10%.

In still other embodiments, a polyamide drilling fluid additive may be use to reduce the amount of solids added to an oil based drilling fluid. In some such embodiments, the drilling fluid has a mud weight of at least 16 ppg. In some such embodiments, a polyamide drilling fluid additive maintains the low shear viscosity of the oil based drilling fluid while simultaneously maintaining a substantially constant high shear viscosity of the oil based drilling fluid compared to a low shear viscosity and high shear viscosity of an oil based drilling fluid without said polyamide drilling fluid additive. In some other embodiments, the oil based drilling fluid further contains an organoclay rheology modifier. In some other such embodiments, the low shear viscosity of the drilling fluid is maintained by ±10%. In some embodiments, the total amount, of polyamide drilling fluid additive in combination with an organoclay, is less than the amount of a rheology modifier consisting of organoclay required to maintain the low shear viscosity of the oil based drilling fluid.

In some embodiments, the polyamide drilling fluid additive imparts temperature stability to the rheology of the oil based drilling fluid. In some embodiments, the oil based drilling fluid, containing the polyamide, maintains the low shear viscosity by ±50% after the drilling fluid is heated to temperatures up to about 300° F. and subsequently cooled to 120° F.

In yet other embodiments, a rheology modifier combination of a polyamide drilling fluid additive and an organclay, impart a synergistic increase in low shear viscosity while simultaneously maintaining a substantially constant high shear viscosity of the oil based drilling fluid compared to the low shear viscosity and high shear viscosity of drilling fluids containing only a polyamide drilling fluid additive or an organoclay as rheology modifier.

For the purposes of this application, the term “about” means plus or minus 10%.

### EXAMPLES

The following examples further describe and demonstrate illustrative embodiments within the scope of the present invention. The examples are given solely for illustration and are not to be construed as limitations of this invention as many variations are possible without departing from the spirit and scope thereof.

### Example 1

A drilling fluid additive was prepared as follows: To a 500 ml reaction kettle equipped with a nitrogen inlet, stirrer, Dean Stark trap and a condenser, a monocarboxylic acid was charged and heated until a molten solid was obtained while stirring at 350 rpm. A polyamine having two amine functionalities was added, at a mole ratio of monocarboxylic acid groups:amine groups ranging from 3:1 to 1:1, and mixed for 5 minutes after which time phosphoric acid was added. The reaction was heated at 200° C. for 6 hours or until the acid and amine values were less than 5. The reaction mixture was cooled to 135° C. and then discharged onto a cooling tray.

### Example 2

A drilling fluid additive was prepared as follows: to a 500 ml reaction kettle equipped with a nitrogen inlet, stirrer, Dean Stark trap and a condenser, docosanoic acid (behenic acid) (MW=340.58) was charged and heated until a molten solid was obtained while stirring at 350 rpm. Diethylene triamine (MW=103) was added and mixed for 5 minutes after which phosphoric acid was added. The reaction was heated at 200° C. for 6 hours. The reaction mixture was cooled to 135° C. and then discharged onto a cooling tray. Sample No. 3168-10.

### Example 3

A drilling fluid additive was prepared as follows: to a 500 ml reaction kettle equipped with a nitrogen inlet, stirrer, Dean Stark trap and a condenser, 12-hydroxystearic acid (MW=300.48) was charged and heated until a molten solid was obtained while stirring at 350 rpm. Diethylene triamine (MW=103) was added and mixed for 5 minutes after which time phosphoric acid was added. The reaction was heated at 200° C. for 6 hours. The reaction mixture was cooled to 135° C. and then discharged onto a cooling tray. Sample No. 3168-03.

### Example 4

A drilling fluid additive was prepared as follows: to a 500 ml reaction kettle equipped with a nitrogen inlet, stirrer, Dean Stark trap and a condenser, 12-hydroxystearic acid (MW=201.02) was charged and heated until a molten solid was obtained while stirring at 350 rpm. Priamine 1074 was added and mixed for 5 minutes after which time phosphoric acid was added. The reaction was heated at 200° C. for 6 hours. The reaction mixture was cooled to 135° C. and then discharged onto a cooling tray. Sample No. 3180-86.

### Example 5

A drilling fluid additive was prepared as follows: to a 500 ml reaction kettle equipped with a nitrogen inlet, stirrer, Dean Stark trap and a condenser, docosanoic acid (behenic acid) (MW=340.58) was charged and heated until a molten solid was obtained while stirring at 350 rpm. Priamine 1074 was added and mixed for 5 minutes after which time phosphoric acid was added. The reaction was heated at 200° C. for 6 hours. The reaction mixture was cooled to 135° C. and then discharged onto a cooling tray. Sample No. 3173-28-1.

### Example 6

A drilling fluid added was prepared following Example 1 of U.S. Pat. No. RE41,588.

Testing of Polyamide Compositions

Drilling fluids containing the polyamide compositions were prepared for evaluation based on various formulations shown in Table 1. The polyamide compositions were evaluated at different loading levels which were dependent upon the efficiency of each polyamide composition in combination with varying amounts of a dialkyl quat-bentone organoclay (“organoclay”).

TABLE 1

| Mud Weight | 12 | 18 | 14 |
|---|---|---|---|
| Base Oil | No. 2 Diesel | Escaid 110 | Synthetic |
| | Oil | | |
| Oil:Water | 85:15 | 90:10 | 85:15 |
| OrganoClay | B-910 | B-42/B990 | B-38 |
| | ppb | ppb | ppb |
| Amine Emulsifier | 10 | 20 | 5 |
| TOFA | 0 | 6 | 0 |
| Lime | 4 | 15 | 10 |
| 25% CaCl₂ brine | 73.5 | 23.8 | 48 |
| OrganoClay | 6-14 | 6.7-12 | 6 |
| Organo Clay B | 0 | 4.5-8 | 0 |
| Amine Treated Lignite | 0 | 15 | 0 |
| Rheology Modifier | 0-4 | 0-3 | 0-4 |

The drilling fluids were dynamically aged using a roller oven for 16 hours at 150° F., 200° F. and 250° F. dependent upon the activation temperature of each polyamide composition, and then statically aged for 16 hours at 40° F. After the drilling fluids were water cooled for one hour, the fluids were mixed on a Hamilton Beach MultiMixer for 10 minutes. Viscosity measurements of the drilling fluids were measured using the OFI-900 at 120° F. after each thermal cycle using test procedures API RP 13B, using standard malt cups and a 5 spindle Hamilton Beach multimixer, except for 40° F. static aging, where the viscosity measurements were made at 40° F. Polyamide composition 3180-94, used in the examples below, has an active content of 40 wt. % bisamide with the remaining 60% as filler.

### Example 7

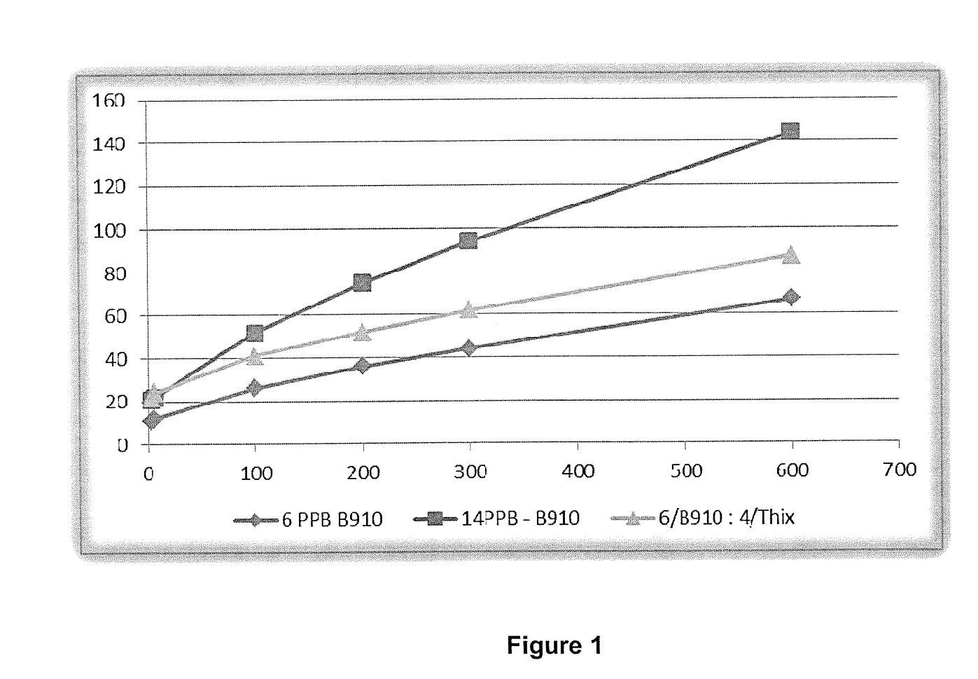

Polyamide composition 3180-94, made from dodecanoic acid and diethylene triamine, was tested at a mud weight of 12 ppg as discussed above. The rheological profile is shown below in Table 2. The addition of 4 ppm of the polyamide, to the drilling fluid composition containing 6 ppb of an organoclay, increased the low shear viscosity, measured at 6 rpm reading, from 12 to 23, and the high shear viscosity, measured at 600 rpm, increased to 87. In contrast, when the organoclay level was increased to 14 ppb, the low shear viscosity increased to 22 and the high shear viscosity increased to 144. The polyamide drilling fluid additive maintained the high shear viscosity to a substantially constant value while increasing the low shear viscosity when compared to the changes in low and high shear viscosities of drilling fluids containing only organoclay. The data of Table 2 is illustrated in FIG. 1.

TABLE 2
Concentrations

| 3180-94 | 0 ppb | 0 ppb | 4 ppb |
|---|---|---|---|
| Organoclay | 6 ppb | 14 ppb | 6 ppb |
| | HR 150° F. | HR 150° F. | 40° F. |
| OFI 900 Visc. @ 120° F. | 120° F. Test | 120° F. Test | 40° F. Test |
| 600 RPM Reading | 67 | 144 | 87 |
| 300 RPM Reading | 44 | 94 | 62 |
| 6 RPM Reading | 12 | 22 | 23 |
| 3 RPM Reading | 11 | 21 | 22 |
| Apparent Visc., cPs | 34 | 72 | 44 |
| Plastic Visc., cPs | 23 | 50 | 25 |
| Yield Point, Lbs/100 ft² | 21 | 44 | 37 |
| LSRYP | 10 | 20 | 20 |
| Electrical Stability, volts | 1074 | 1236 | 1305 |
| 10 Sec Gel | 12 | 26 | 26 |

### Example 8

Polyamide composition 3180-95, made from dodecanoic acid and diethylene trimaine, was tested at a mud weight of 18 ppg as discussed above. The rheological profile is shown below in Table 3.

TABLE 3
Concentrations

| 3180-95 | 0 ppb | 2 ppb | 0 ppb | 3 ppb |
|---|---|---|---|---|
| Organoclay A/B | 10/6.7 ppb | 6.7/4.5 ppb | 12/8 ppb | 6.7/45. |
| | HR 150° F. | HR 150° F. | HR 150° F. | HR 150° F. |
| OFI 900 Visc. @ 120° F. | 120° F. Test | 120° F. Test | 120° F. Test | 120° F. Test |
| 600 RPM Reading | 170 | 131 | 212 | 153 |
| 300 RPM Reading | 105 | 81 | 134 | 99 |
| 6 RPM Reading | 16 | 14 | 24 | 25 |
| 3 RPM Reading | 13 | 13 | 20 | 23 |
| Apparent Visc., cPs | 85 | 65 | 106 | 77 |
| Plastic Visc., cPs | 65 | 50 | 78 | 54 |
| Yield Point, Lbs/100 ft² | 40 | 31 | 56 | 45 |
| TAU 0, lbs/100 ft² | 10 | 12 | 16 | 21 |
| Electrical Stability | 1533 | 1236 | 1576 | 1590 |
| 10 Sec Gel, Lbs/100 ft² | 21 | 18 | 30 | 25 |

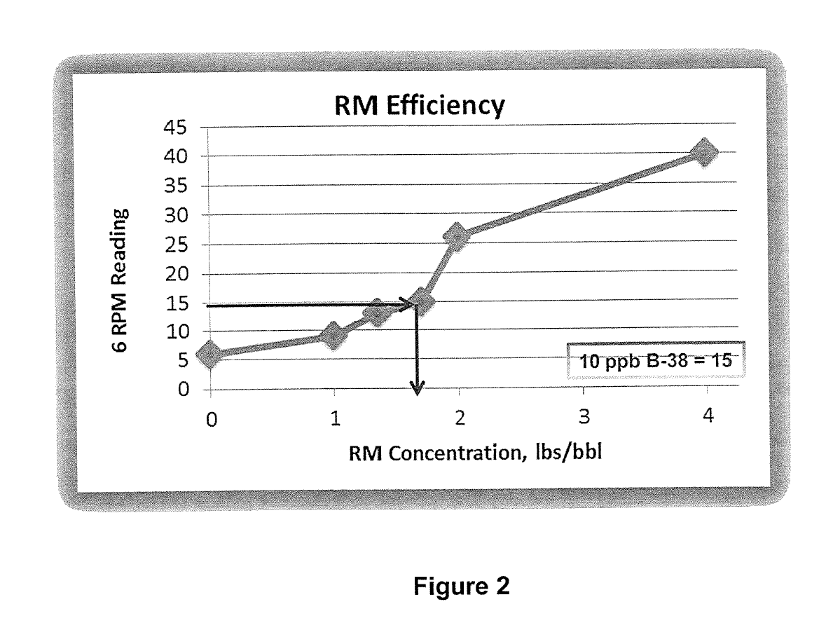

The data in Table 3 demonstrates that it is possible to reduce the total amount rheological additive in a drilling fluid composition, the polyamide in combination with organoclay, by adding the polyamide drilling fluid additive and reducing the amount of organoclay. As illustrated in Table 3, a drilling fluid containing 16.7 ppb organoclay had a low shear viscosity of 16 and a high shear viscosity of 170. In contrast, a drilling fluid containing 6.7 ppb organoclay and 4.5 ppb polyamide (11.2 ppb total rheological additive amount) had a low shear viscosity of 14 and a high shear viscosity of 131. However, the total amount of added rheological additive was reduced from 16.7 ppb organoclay to 13.2 ppb organoclay and polyamide additive while maintaining the low shear viscosity by 12% and decreasing the high shear viscosity from 170 to 131. The data of Table 3 is illustrated in FIG. 2.

### Example 9

Polyamide composition 3168-11, made from docosanoic acid and diethylene trimine, was tested at a mud weight of 14 ppg as discussed above. The rheological profile is shown below in Table 4.

TABLE 4
Concentrations

| 3168-11 | 0 ppb | 1.0 ppb | 1.35 | 1.7 ppb | 2.0 ppb | 4.0 ppb |
|---|---|---|---|---|---|---|
| | | | ppb | | | |
| BENTONE ® | 6 ppb | 6 ppb | 6 ppb | 6 ppb | 6 ppb | 6 ppb |
| 38 | HR | HR | HR | HR | HR | HR |
| | 150° F. | 150° F. | 150° F. | 150° F. | 150° F. | 150° F. |
| OFI 900 Visc. | 120° F. | 120° F. | 120° F. | 120° F. | 120° F. | 120° F. |
| @ 120° F. | Test | Test | Test | Test | Test | Test |
| 600 RPM | 57 | 61 | 76 | 77 | 96 | 112 |
| Reading | | | | | | |
| 300 RPM | 32 | 36 | 48 | 50 | 69 | 85 |
| Reading | | | | | | |
| 6 RPM | 6 | 9 | 13 | 15 | 26 | 40 |
| Reading | | | | | | |
| 3 RPM | 5 | 8 | 38 | 14 | 24 | 39 |
| Reading | | | | | | |
| Apparent Visc., | 29 | 31 | 38 | 39 | 48 | 56 |
| cPs | | | | | | |
| Plastic Visc., | 25 | 25 | 28 | 27 | 27 | 27 |
| cPs | | | | | | |
| Yield Point, | 7 | 11 | 20 | 23 | 42 | 58 |
| Lbs/100 ft² | | | | | | |
| LSRYP | 4 | 7 | 11 | 13 | 22 | 38 |
| Electrical | 1185 | 1613 | 1632 | 1162 | 1415 | 1799 |
| Stability, volts | | | | | | |
| 10 Sec Gel, | 7 | 11 | 15 | 15 | 24 | 38 |
| Lbs/100 ft² | | | | | | |

The data of Table 4 demonstrates that the polyamide rheology modifier is more efficient at increasing low shear viscosity compared to an organoclay. This data is illustrated in FIG. 2.

### Example 10

Polyamide composition 3168-11, made from docosanoic acid and diethylene trimine, was tested at a mud weight of 12 ppg and varying amounts of emulsifier as discussed above. The emulsifier included an amine composition and tallow fatty acid. The rheological profile is shown below in Table 5.

TABLE 5
Concentrations

| 3168-11 | 2 ppb | 2 ppb | 2 ppb | 2 ppb | 2 ppb | 2 ppb |
|---|---|---|---|---|---|---|
| BENTONE ® | 6 ppb | 6 ppb | 6 ppb | 6 ppb | 6 ppb | 6 ppb |
| 910 | | | | | | |
| Amine/TOFA | 3.5/1.5 | 7/3 | 10.5/4.5 | 5/0 | 10/0 | 15/0 |
| | HR | HR | HR | HR | HR | HR |
| | 150° F. | 150° F. | 150° F. | 150° F. | 150° F. | 150° F. |
| OFI 900 Visc. | 120° F. | 120° F. | 120° F. | 120° F. | 120° F. | 120° F. |
| @120° F. | Test | Test | Test | Test | Test | Test |
| 600 RPM | 78 | 75 | 69 | 76 | 73 | 73 |
| Reading | | | | | | |
| 6 RPM | 18 | 15 | 12 | 18 | 17 | 16 |
| Reading | | | | | | |
| Apparent | 39 | 38 | 35 | 38 | 37 | 37 |
| Visc., cPs | | | | | | |
| Plastic | 24 | 25 | 24 | 23 | 24 | 24 |
| Visc., cPs | | | | | | |
| Yield Point, | 30 | 25 | 21 | 30 | 25 | 25 |
| Lbs/100 ft² | | | | | | |
| LSRYP | 16 | 13 | 10 | 16 | 15 | 14 |
| Electrical | 865 | 1078 | 1141 | 886 | 1123 | 1359 |
| Stability, volts | | | | | | |
| 10 Sec Gel, | 20 | 17 | 13 | 20 | 19 | 18 |
| Lbs/100 ft² | | | | | | |

### Example 11

Polyamide composition 3168-11, made from docosanoic acid and diethylene trimine, was tested at a mud weight of 12 ppg, Escaid 110 base oil, and water to oil ratio of 85:15, with and without an organoclay rheology modifier. The rheological measurements were made as discussed above. The rheological data are shown below in Table 6.

For a drilling fluid containing Escaid 110 base oil, water to oil ratio of 85:15, mud weight of 12 ppg and 12 ppb organoclay rheology modifier, the low shear viscosity reading was 6 after hot rolling at 150° F. and measured at 120° F.

The data illustrates the synergistic relationship between the polyamide drilling fluid and an organoclay.

TABLE 6
Concentrations

| Organoclay | 0 | 0 | 0 | 0 | 12 ppb |
|---|---|---|---|---|---|
| 3180-95 | 10 ppb | 20 ppb | 30 ppb | 40 ppb | 2 ppb |
| | | | | | HR |
| | | | | | 150° F. |
| | | | | HR 150° F. | 120° F. |
| OFI 900 Visc. @ 120° F. | 120° F. Test | 120° F. Test | 120° F. Test | 120° F. Test | Test |
| 600 RPM Reading | 0 | 37 | 66 | To Viscous | 79 |
| 6 RPM Reading | 0 | 3 | 20 | | 18 |
| Apparent Visc., cPs | NA | 19 | 33 | | 40 |
| Plastic Visc., cPs | NA | 16 | 19 | | 24 |
| Yield Point, Lbs/100 ft² | NA | 5 | 28 | | 31 |
| LSRYP | NA | 1 | 18 | | 4 |
| Electrical Stability | NA | 696 | 1542 | | 1089 |
| 10 Sec Gel, Lbs/100 ft² | NA | 3 | 25 | | 20 |

### Example 12

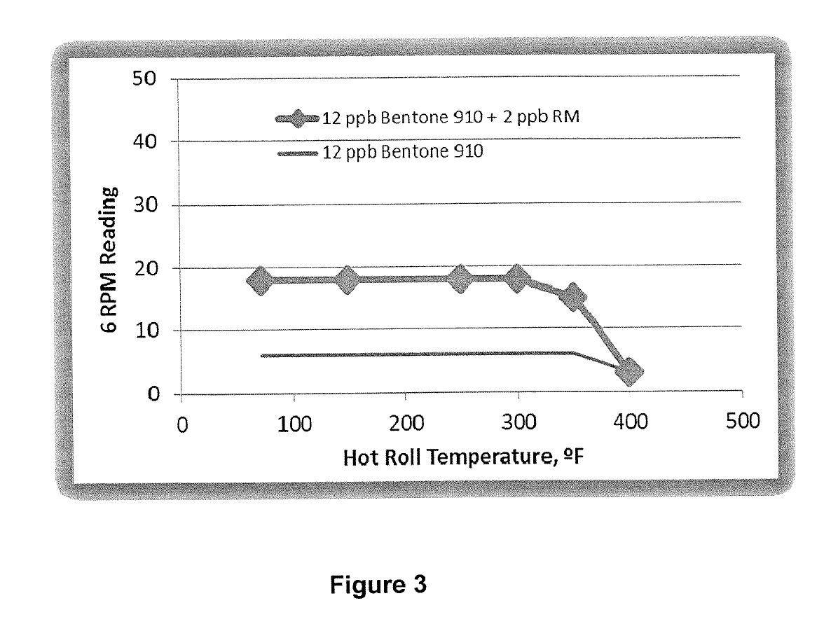

The temperature stability of a bisamde drilling fluid additive was tested by using a drilling fluid, based on a Escaid continuous fluid, 85:15 oil to water ratio, 12 ppg mud weight, 12 ppb organoclay and 2 ppb bisamide. The drilling fluid was aged using a roller oven for 16 hours at 75° F., 150° F., 250° F., 300° F., 350° F. and 400° F. Viscosity measurements of the drilling fluids were measured using the OFI-900 at 120° F. after each heat treatment as described above. The low shear viscosity readings as a function of aging temperature are illustrated in FIG. 3.

### Example 13

Jefferson sag test measurements were also obtained for drilling fluid having a mud weight of 12 ppg and Escaid 110 base oil, and water to oil ratio of 85:15.

TABLE 7
Concentrations

| 3180-95 | 0 ppb | 2 ppb | 0 ppb | 2.6 ppb |
|---|---|---|---|---|
| Organoclay | 18 ppb | 13 ppb | 21 ppb | 12 ppb |
| | HR 150° F. | HR 150° F. | HR 150° F. | HR 150° F. |
| OFI 900 Visc. @ 120° F. | 120° F. Test | 120° F. Test | 120° F. Test | 120° F. Test |
| 600 RPM Reading | 93 | 74 | 127 | 80 |
| 6 RPM Reading | 12 | 12 | 16 | 16 |
| Apparent Visc., cPs | 47 | 37 | 64 | 40 |
| Plastic Visc., cPs | 35 | 26 | 45 | 25 |
| Yield Point, Lbs/100 ft² | 23 | 22 | 45 | 25 |
| TAU 0, lbs/100 ft² | 8 | 10 | 11 | 13 |
| Electrical Stability | 908 | 1058 | 1110 | 1095 |
| 10 Sec Gel, Lbs/100 ft² | 14 | 14 | 18 | 16 |
| Sag lbs/gal | 1.81 | 1.10 | 0.97 | 0.55 |

### Example 14

A summary of rheological properties for various polyamide compositions tested in a drilling fluid based on IAO base oil, 80:20 oil:water, 12 ppg mud weight, 10 ppb emulsifier, 4 ppb lime, 73.5 ppb 25% CaCl₂ brine and rheology additives as shown below.

TABLE 8

| | | | | | Load Level | | | | | |
|---|---|---|---|---|---|---|---|---|---|---|
| | Carboxylic Acid | Polyamine | | | (PPB) | 6 RPM | 600 RPM | | | |
| | Source (R1) | (R2) | | | Organoclay/ | HR | HR | | | |
| Additive | (R1) | (R2) | Activity | R1/R2 | Additive | (150° F.) | (150° F.) | PV | YP | TAU |
| Organoclay | NA | NA | — | | [3/0] | 7 | 56 | 22 | 12 | 7 |
| Organoclay | NA | NA | — | | [6/0] | 13 | 65 | 23 | 19 | 11 |
| Organoclay | NA | NA | — | | [8/0] | 20 | 99 | 32 | 35 | 16 |
| Organoclay | NA | NA | — | | [10/0] | 27 | 120 | 39 | 42 | 21 |
| Polyamide | dimer acid | DETA | 50% | 1:1 | [3/1] | 63 | 9 | 24 | 15 | 7 |
| Polyamide | dimer acid | DETA | 50% | 1:1 | [3/2] | 94 | 21 | 32 | 30 | 19 |
| Polyamide | dimer acid | DETA | 50% | 1:1 | [3/4] | 67 | 12 | 24 | 19 | 8 |
| 3180-94 | Lauric acid | DETA | 100% | 2:1 | [3/1] | 53 | 9 | 20 | 13 | 7 |
| 3180-94 | Lauric acid | DETA | 100% | 2:1 | [3/2] | 68 | 16 | 20 | 28 | 14 |
| 3180-94 | Lauric acid | DETA | 100% | 2:1 | [3/4] | 81 | 23 | 23 | 35 | 21 |
| 3180-95 | Lauric acid | DETA | 100% | 3:1 | [3/1] | 65 | 16 | 23 | 19 | 14 |
| 3180-95 | Lauric acid | DETA | 100% | 3:1 | [3/2] | 65 | 15 | 22 | 21 | 13 |
| 3180-95 | Lauric acid | DETA | 100% | 3:1 | [3/4] | 75 | 20 | 24 | 27 | 18 |
| 3168-25 | Ricinoleic Acid | MXDA | 100% | 2:1 | [3/2] | 52 | 8 | 22 | 8 | 6 |
| 3168-25 | Ricinoleic Acid | MXDA | 100% | 2:1 | [3/4] | 54 | 10 | 20 | 14 | 8 |
| 3180-86 | 12- | DETA | 100% | 2:1 | [3/2] | 91 | 21 | 26 | 39 | 19 |
| | hydroxystearic | | | | | | | | | |
| | acid | | | | | | | | | |
| 3168-03 | 12- | DETA | 100% | 2:1 | [3/4] | 114 | 32 | 28 | 58 | 30 |
| | hydroxystearic | | | | | | | | | |
| | acid | | | | | | | | | |
| 3168-03 | 12- | DETA | 100% | 3:1 | [3/2] | 57 | 9 | 23 | 11 | 7 |
| | hydroxystearic | | | | | | | | | |
| | acid | | | | | | | | | |
| 3168-02 | 12- | DETA | 100% | 3:1 | [3/4] | 73 | 16 | 25 | 23 | 12 |
| | hydroxystearic | | | | | | | | | |
| | acid | | | | | | | | | |
| 3168-02 | 12- | DETA | 100% | 3:1 | [3/6] | 100 | 28 | 25 | 50 | 26 |
| | hydroxystearic | | | | | | | | | |
| | acid | | | | | | | | | |

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the preferred embodiments of the disclosure, it is noted that other variations and modifications will be apparent to those skilled in the art, and may be made without departing from the spirit or scope of the disclosure.

1. A method of drilling in a subterranean formation comprising the steps of:
(a) providing an oil based drilling fluid by combining an oil based continuous phase with a drilling fluid additive, said oil based drilling fluid having a low shear viscosity and a high shear viscosity, said drilling fluid additive comprising a polyamide having constituent units of:
i. a carboxylic acid unit having a single carboxylic moiety or two carboxylic moieties and
ii a polyamine unit having at least two primary amino groups and optionally at least one secondary amino group,
wherein the drilling fluid additive maintains or increases the low shear viscosity of the oil based drilling fluid while simultaneously maintaining a substantially constant high shear viscosity of the oil based drilling fluid compared to a low shear viscosity and high shear viscosity of an oil based drilling fluid without said polyamide;
(b) placing the oil based drilling fluid into the subterranean formation.

2. The method of claim 1, wherein the carboxylic acid unit having one carboxylic moiety is derived from one or more compounds of the formula R¹—COOH wherein R¹ is a saturated or unsaturated hydrocarbon having from 8 carbon atoms to 22 carbon atoms.

3. The method of claim 2, wherein R¹ is an unsaturated hydrocarbon having from 8 carbon atoms to 22 carbon atoms and wherein R¹ is optionally substituted with one or more hydroxyl groups.

4. The method of claim 1, wherein the carboxylic acid unit having one carboxylic moiety is derived from one or more compounds of the formula R¹—COOH wherein R¹ is a saturated or unsaturated hydrocarbon having from 12 carbon atoms to 22 carbon atoms.

5. The method of claim 4, wherein R¹ is an unsaturated hydrocarbon having from 12 carbon atoms to 22 carbon atoms and wherein R¹ is optionally substituted with one or more hydroxyl groups.

6. The method of claim 1, wherein the carboxylic acid unit having one carboxylic moeity is derived from a monocarboxylic acid selected from the group consisting of: dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof.

7. The method of claim 1, wherein the carboxylic acid unit having two carboxylic moieties is derived from a dimer fatty acid.

8. The method of claim 7, wherein dimer fatty acid is selected from the group consisting of hydrogenated, partially hydrogenated and non-hydrogenated dimer acids with from about 20 to about 48 carbon atoms.

9. The method of claim 1, wherein the polyamine unit is derived from a linear or branched aliphatic or aromatic diamine having from 2 to 36 carbon atoms.

10. The method of claim 9, wherein the polyamine unit is derived from a polyamine selected from a group consisting of ethylenediamine, tetramethylenediamine, pentamethylenediamine, hexamethylenediamine, diethylenetriamine, metaxylene diamine and mixtures thereof.

11. (canceled)

12. The method of claim 1, further comprising adding an organoclay to the oil-base drilling fluid.

13. (canceled)

14. The method of claim 1, wherein the oil based drilling fluid has a mud weight of at least 16 ppg and wherein the amount of polyamide drilling fluid additive is less than the amount of a rheology modifier consisting of an organoclay rheology modifier required to maintain the low shear viscosity of the oil based drilling fluid.

15. (canceled)

16. (canceled)

17. (canceled)

18. (canceled)

19. A method of drilling in a subterranean formation comprising the steps of:
(a) providing an oil based drilling fluid by combining an oil based continuous phase with a drilling fluid additive comprising a polyamide which is a reaction product of:
i. a carboxylic acid having a single carboxylic moiety or two carboxylic moieties; and
ii. a polyamine having at least two primary amino groups and optionally at least one secondary amino group wherein the drilling fluid additive increases a low shear viscosity of the oil based drilling fluid while simultaneously maintaining a substantially constant high shear viscosity of the oil based drilling fluid;
(b) placing the oil based drilling fluid into the subterranean formation.

20. The method of claim 19, wherein the carboxylic acid having a single carboxylic moiety has a formula R¹—COOH wherein R¹ is a saturated or unsaturated hydrocarbon having from 8 carbon atoms to 22 carbon atoms.

21. The method of claim 20, wherein R¹ is an unsaturated hydrocarbon having from 8 carbon atoms to 22 carbon atoms and wherein R¹ is optionally substituted with one or more hydroxyl groups.

22. The method of claim 19, wherein the carboxylic acid unit having one carboxylic moiety is derived from one or more compounds of the formula R¹—COOH wherein R¹ is a saturated or unsaturated hydrocarbon having from 12 carbon atoms to 22 carbon atoms.

23. The method of claim 22, wherein R¹ is an unsaturated hydrocarbon having from 12 carbon atoms to 22 carbon atoms and wherein R¹ is optionally substituted with one or more hydroxyl groups.

24. The method of claim 19, wherein the carboxylic acid unit having one carboxylic moiety is selected from the group consisting of: dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof.

25. The method of claim 19, wherein the polyamine comprises a linear or branched aliphatic or aromatic diamine having from 2 to 36 carbon atoms.

26. The method of claim 25, wherein the polyamine selected from a group consisting of ethylenediamine, tetramethylenediamine, pentamethylenediamine, hexamethylenediamine, diethylenetriamine, metaxylene diamine and mixtures thereof.
